(19) United States
(12) Patent Application Publication
(10) Pub. No.: US 2005/0018449 A1
(43) Pub. Date: Jan. 27, 2005

(54) Rotating mechanism for an ornament

(76) Inventor: Lieh-Liang Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/622,577

(22) Filed: Jul. 21, 2003

(51) Int. Cl. F21S 4/00

(52) U.S. Cl. 362/565

(57) ABSTRACT

A rotating mechanism for an ornament includes a base including a first transmission seat, a second transmission seat, and a pair of third transmission seats. A pair of pivot holes is defined in the second transmission seat. A first transmission member is rotatably mounted on the first transmission seat. A groove is defined in the side wall of the first transmission member. A second transmission member is mounted on the second transmission seat. The second transmission member includes a head movably received in the groove of the first transmission member, a pair of pivots at opposite side surfaces thereof, and a pair of shoulders. The pivots are pivotably received in the pivot holes of the second transmission seat. A pair of third transmission members is rotatably mounted on the third transmission seats respectively. Each shoulder of the second transmission member movably engages with each third transmission member. When the groove of the first transmission member actuates the head of the second transmission member thereby rotating the second transmission member about the pivots thereof, the shoulders of the second transmission member actuate the third transmission members thereby rotating the third transmission members.

### BACKGROUND OF THE INVENTION

1. Field of the Invention

The present invention relates to a rotating mechanism, and particularly to a rotating mechanism for an ornament.

2. Prior Art

Many kinds of ornaments can perform a predetermined cyclical motion respectively, which makes the ornaments lovely and attractive. For example, an angel ornament has a pair of wings which can swing mimically. In general, each ornament includes a rotating mechanism for performing the cyclical motion.

As shown in FIGS. 1-3, a conventional rotating mechanism for an ornament includes a reversed cup-shaped base 80 receiving a motor (not shown) therein. A cam 81 is rotatably mounted on the base 80 and driven by the motor. A slidebar 82 is movably engaged with a guide rail 84 formed at the base 80. A head 83 is formed at an end of the slidebar 82 with an elliptic hole defined therein. The cam 81 is partly and rotatably received in the elliptic hole of the head 83. A pair of racks 87 is formed at side surfaces of the slidebar 82, respectively. A pair of gears 88 is rotatably mounted on the base 80 and mates with the pair of racks 87 respectively. A cover 85 is mounted to the base 80 thereby sandwiching the cam 81, the slidebar 82 and the gears 88 between the cover 85 and the base 80. A guide way 86 extends from the cover 85 for guiding the slidebar 82. A pair of sleeves 89 for carrying some parts of the ornament extends through the cover and is fixedly received in the gears 88 respectively. Thus, when the cam 81 is driven by the motor, the slidebar 82 is driven to move to and fro and causes the gears 88 and the sleeves 89 to rotate back and forth whereby the parts of the ornament can perform a cyclical motion.

However, wearing occurs during the racks 87 mating with the gears 88. After a long term of working, the wearing of the racks 87 and the gears 88 adversely affects working stability of the rotating mechanism, or even causes the rotating mechanism out of operation.

Furthermore, parts of the ornament are assembled to the sleeves 89 and then the sleeves 89 are fixed to the gears 88 respectively. It is complicated to make sure that the parts are located at the right position relative to other parts of the ornament, since there is not a positioning device between the sleeves 89 and the gears 88.

### SUMMARY OF THE INVENTION

Accordingly, an object of the present invention is to provide a rotating mechanism for an ornament which can reduce wearing and improve working stability.

Another object of the present invention is to provide a rotating mechanism for an ornament which is ready to position sleeves thereto.

To achieve the above-mentioned objects, a rotating mechanism for an ornament in accordance with the present invention includes a base including a first transmission seat, a second transmission seat, and a pair of third transmission seats. A pair of pivot holes is defined in the second transmission seat. A first transmission member is rotatably mounted on the first transmission seat. A groove is defined in the side wall of the first transmission member. A second transmission member is mounted on the second transmission seat. The second transmission member includes a head movably received in the groove of the first transmission member, a pair of pivots at opposite side surfaces thereof, and a pair of shoulders. The pivots are pivotably received in the pivot holes of the second transmission seat. A pair of third transmission members is rotatably mounted on the third transmission seats respectively. Each shoulder of the second transmission member movably engages with each third transmission member. When the groove of the first transmission member actuates the head of the second transmission member thereby rotating the second transmission member about the pivots thereof, the shoulders of the second transmission member actuate the third transmission members thereby rotating the third transmission members.

The rotating mechanism for an ornament further includes a pair of sleeves received in the third transmission members respectively. A cutout is defined in an end wall of each third transmission member. Each sleeve comprises a protrusion for engaging with the cutout of the third transmission member thereby readily positioning the sleeve to the third transmission member.

Other objects, advantages and novel features of the present invention will be drawn from the following detailed embodiment of the present invention with attached drawings, in which:

### BRIEF DESCRIPTION OF THE DRAWINGS

FIG. 1 is an exploded view of a conventional rotating mechanism for an ornament;

FIG. 2 is a front elevational and assembled view of FIG. 1;

FIG. 3 is a side elevational and assembled view of FIG. 1;

FIG. 4 is an exploded view of a rotating mechanism for an ornament in accordance with the present invention;

FIG. 5 is similar to FIG. 4 but showing part of FIG. 4;

FIG. 6 is a front elevational and assembled view of FIG. 4;

FIG. 7 is a side elevational and assembled view of FIG. 4;

FIG. 8 is a top plan and assembled view of FIG. 4;

FIG. 9 is a schematic view showing the rotating mechanism of the present invention being used in an angel ornament;

FIG. 10 is a schematic view showing a wing of the angel ornament being fixed to a sleeve of the rotating mechanism;

FIG. 11 is a schematic view showing flowers being fixed to a fixing tube of the rotating mechanism;

FIG. 12 is a schematic view of the angel ornament showing wings being swung to a close position; and

FIG. 13 is a schematic view of the angel ornament showing wings being swung to an open position.

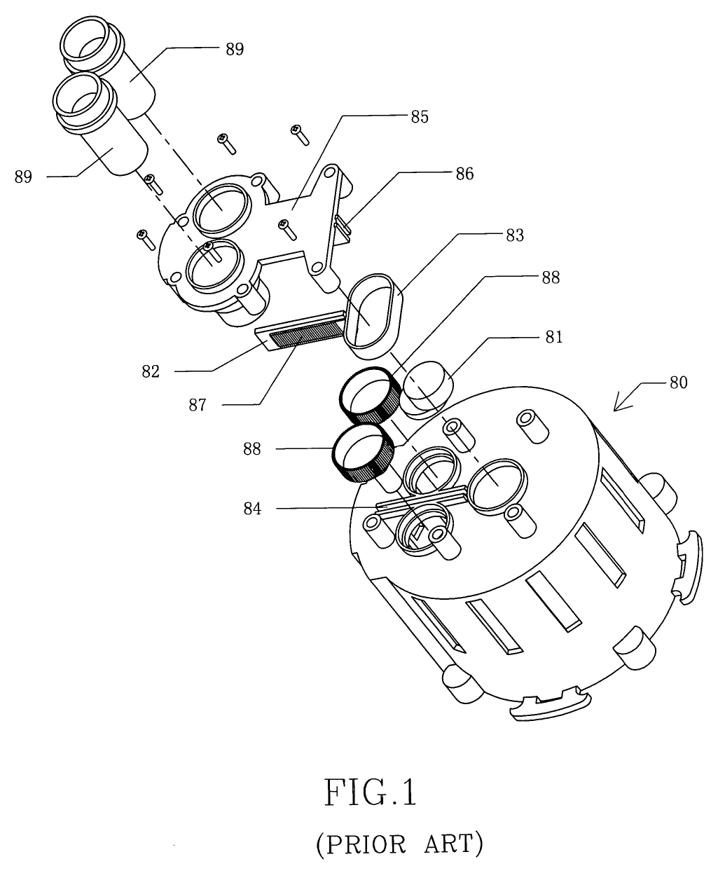

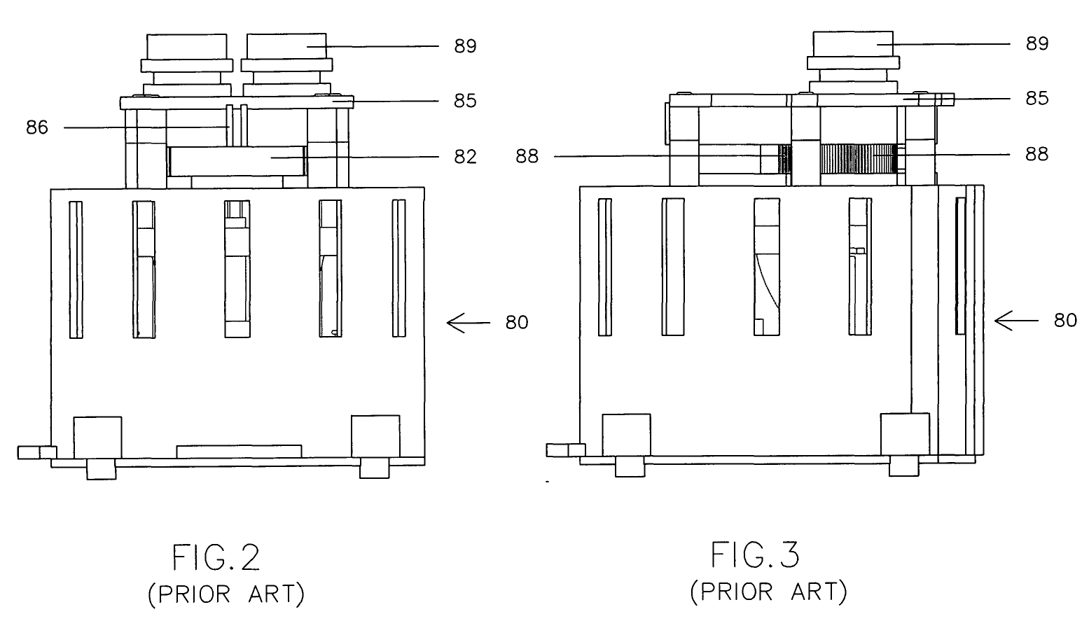

### DESCRIPTION OF THE PREFERRED EMBODIMENT

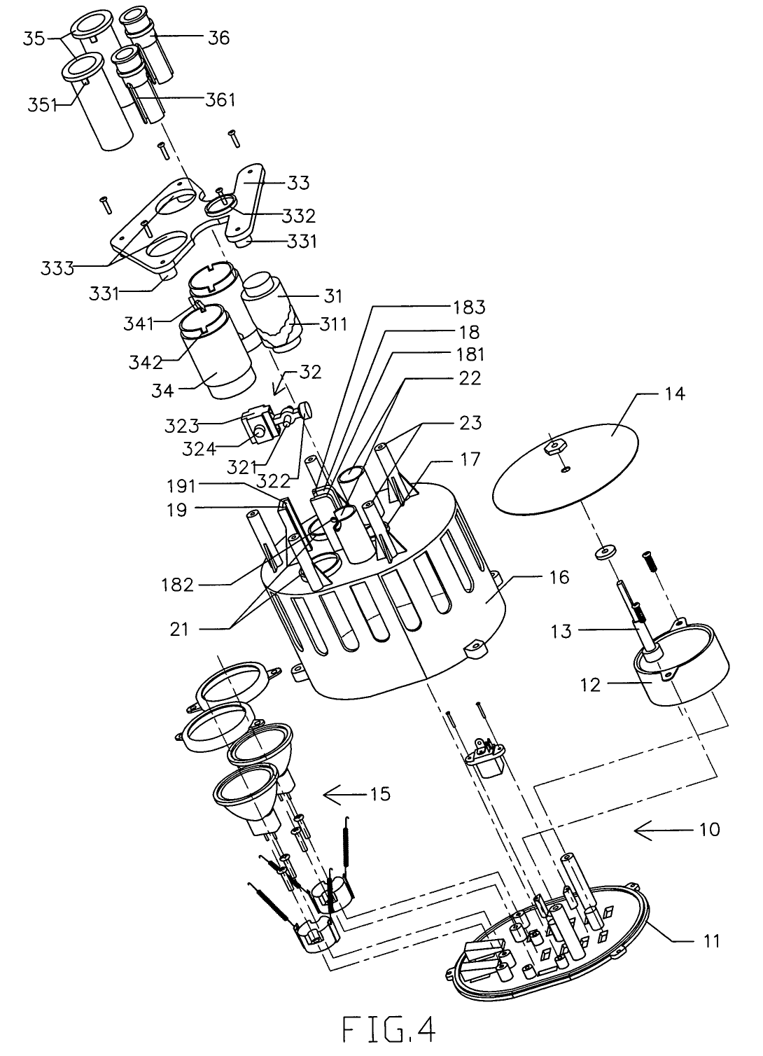

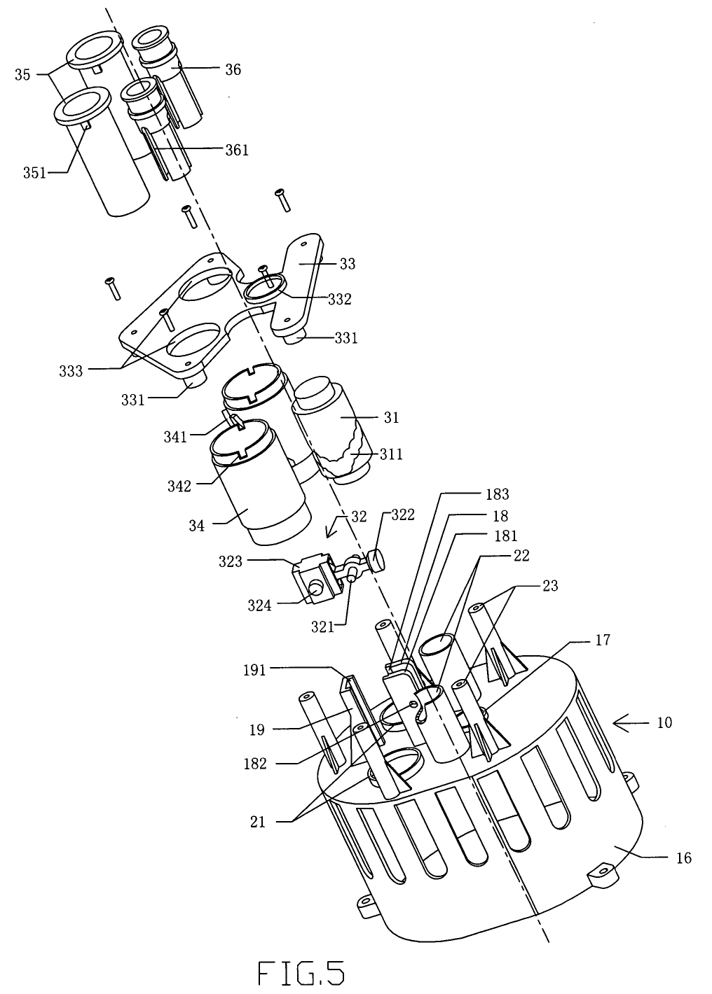

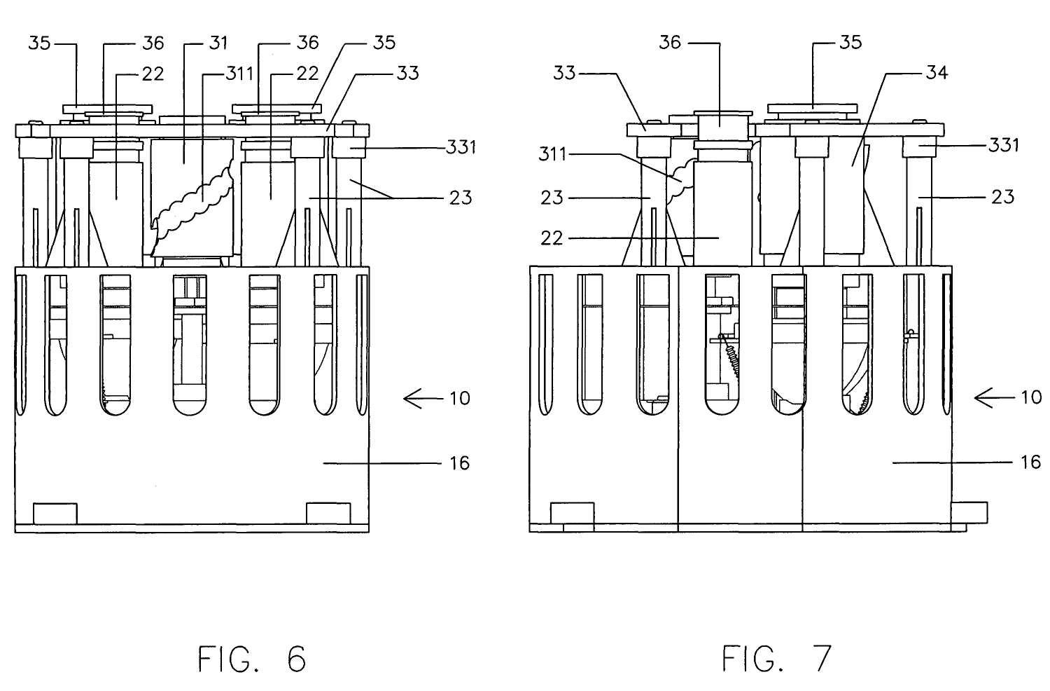

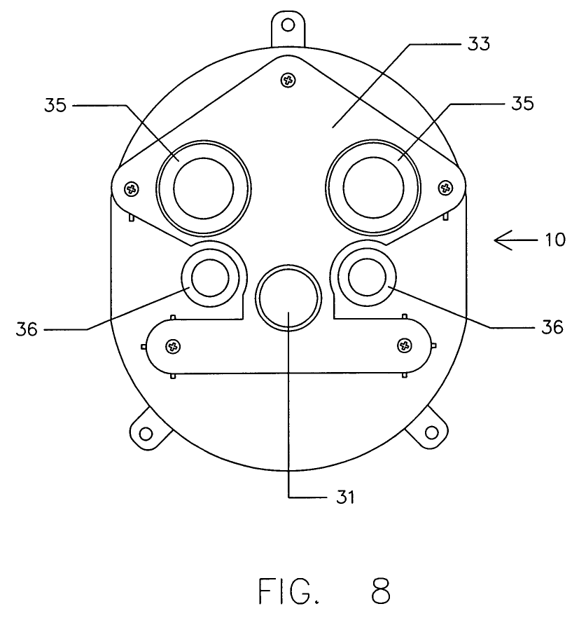

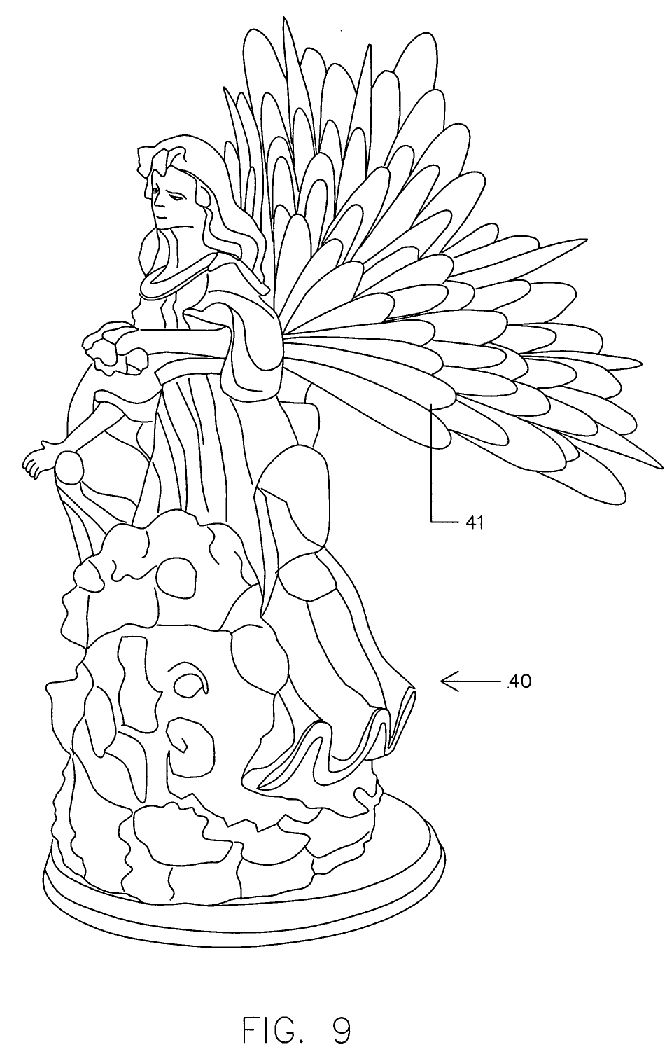

Referring to FIGS. 4-8, a rotating mechanism for an ornament of the present invention includes a base assembly 10, a first transmission member 31, a second transmission member 32, a pair of third transmission members 34, a cover 33, and a pair of sleeves 35.

The base assembly 10 includes a base 16. A housing 11 is attached to the base 16. A motor 12 is mounted on the housing 11 and received in the base 16. A rotating shaft 13 extends from the motor 12. A transparent multicolored plate 14 is attached to the rotating shaft 13 thereby rotating with the rotating shaft 13. A pair of lamps 15 is mounted on the housing 11 and under the transparent multicolored plate 14. When the motor 12 and the lamps 15 work, light coming from the lamps 15 goes through the rotating transparent multicolored plate 14 whereby multicolored light occurs and shines. Furthermore, a music loaded circuit (not shown) may be provided in the base assembly 10.

The base 16 includes a first transmission seat 17, a second transmission seat (described hereinafter), a pair of third transmission seats 21 and five mounting posts 23. The first transmission member 31 is rotatably mounted on the first transmission seat 17 and connected with the shaft 13 of the motor 12. A groove 311 is defined in the side wall of the first transmission member 31. The groove 311 includes two symmetrical spired sections connected with each other.

A supporter 18 and a guide rail 19 are formed at the base 16 thereby cooperatively defining the second transmission seat. The supporter 18 includes a pair of boards 181 each with a pivot hole 182 and an L-shaped recess 183 defined therein. The L-shaped recesses 183 face each other thereby cooperatively defining a guide way. A U-shaped recess 191 is defined in the guide rail 19. The second transmission member 32 is mounted on the second transmission seat. The second transmission member 32 includes a head 322 at one end thereof, a guide body 323 at the other end thereof, and a pair of pivots 321 at opposite side surfaces thereof between the head 322 and the guide body 323. A pair of circular shoulders 324 extends from opposite side surfaces of the guide body 323. The pivots 321 are pivotably received in the pivot holes 182 of the supporter 18. The head 322 is movably received in the groove 311 of the first transmission member 31. The guide body 323 is movable along the guide rail 19 and the guide way of the supporter 18.

The third transmission members 34 are rotatably mounted on the third seats 21 respectively. Each third transmission member 34 includes a pair of guide ribs 341 at the peripheral side wall thereof. Each circular shoulder 324 of the second transmission member 32 is movably received between the guide ribs 341 and movably engages with the guide ribs 341. The pairs of guide ribs 341 of the third transmission members 34 are symmetrical. A pair of cutouts 342 is defined in an end wall of each third transmission member 34.

The cover 33 includes five positioning posts 331 attached to the five mounting posts 23 of the base 16 by bolts. A first through hole 332 and a pair of second through holes 333 are defined in the cover 33 corresponding to the first transmission seat 17 and the third transmission seats 21 respectively. The cover 33 is attached to the base 16 thereby fixing the first and third transmission members 31, 34 to the base 16.

The sleeves 35 extend through the second through holes 333 of the cover 33 and are received in the third transmission member 34, respectively. Each sleeve 35 includes a pair of protrusions 351 for engaging with the cutouts 342 of the third transmission member 34 thereby readily positioning the sleeves 35 to the third transmission members 34.

In operation, the first transmission member 31 is driven to rotate by the motor 12. The spired groove 311 actuates the head 322 of the second transmission member 32 thereby rotating the second transmission member 32 about the pivots 321 thereof. The guide body 323 moves along the guide rail 19 and the guide way of the supporter 18. Meanwhile, the circular shoulders 324 of the second transmission member 32 actuate the guide ribs 341 of the third transmission members 34 thereby rotating the third transmission members 34 and the sleeves 35. Since the pairs of guide ribs 341 of the third transmission members 34 are symmetrical, the transmission members 34 rotate respectively at opposite directions. Since the groove 311 includes two symmetrical spired sections connected with each other, the first transmission member 31 causes the second transmission member 32 to rotate back and forth. Sequentially, the second transmission member 32 causes the third transmission members 35 to rotate back and forth. So, the sleeves 35 rotate back and forth. Thus, the rotating mechanism for an ornament of the present invention is simple and can reduce wearing and improve working stability, compared with the conventional rotating mechanism with a rack and gears.

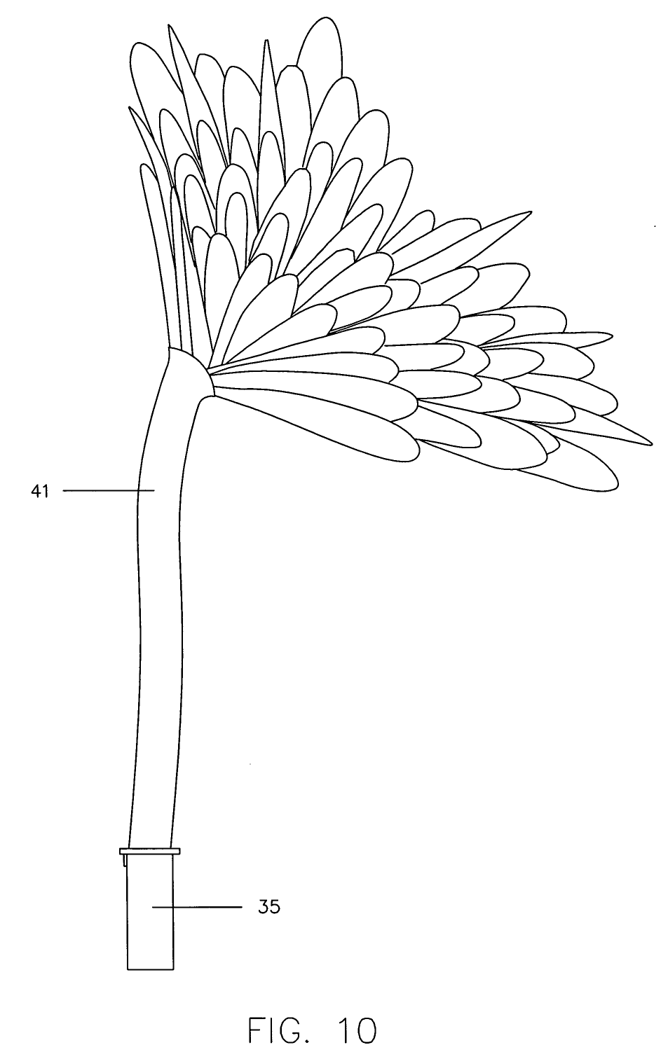

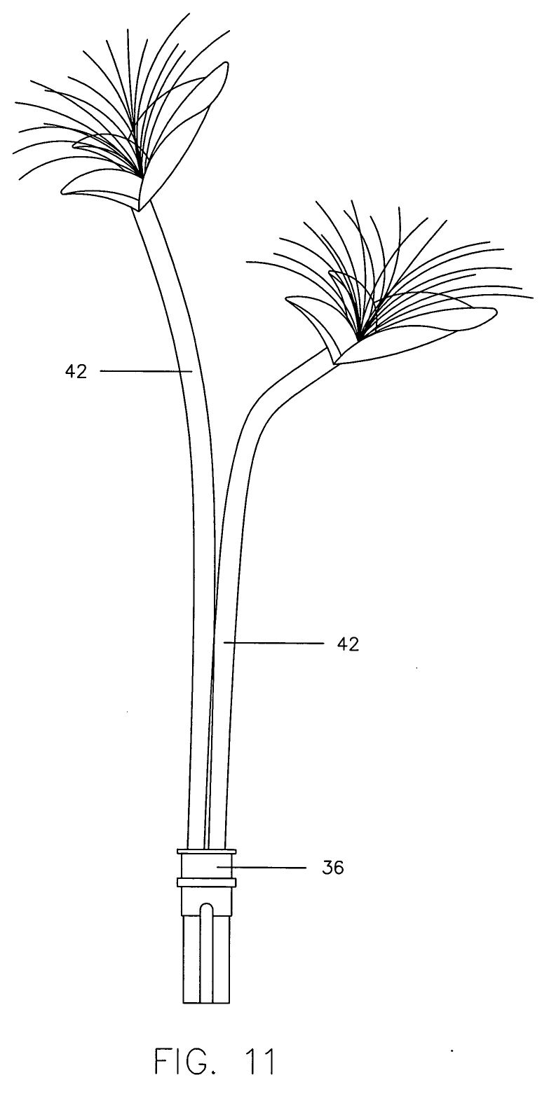

Also referring to FIGS. 9-10, for example, a rotating mechanism of the present invention is adopted in an angel ornament. The angel ornament includes a body 40 and a pair of wings 41 back of the body 40. The wings 41 are fixed to the sleeves 35 respectively. Since the sleeves 35 has protrusions 351 for engaging with the cutouts 342 of the third transmission member 34 thereby readily positioning the sleeves 35 to the third transmission members 34, it is ready to make sure that the wings 41 are located at a right position relative to the body 40.

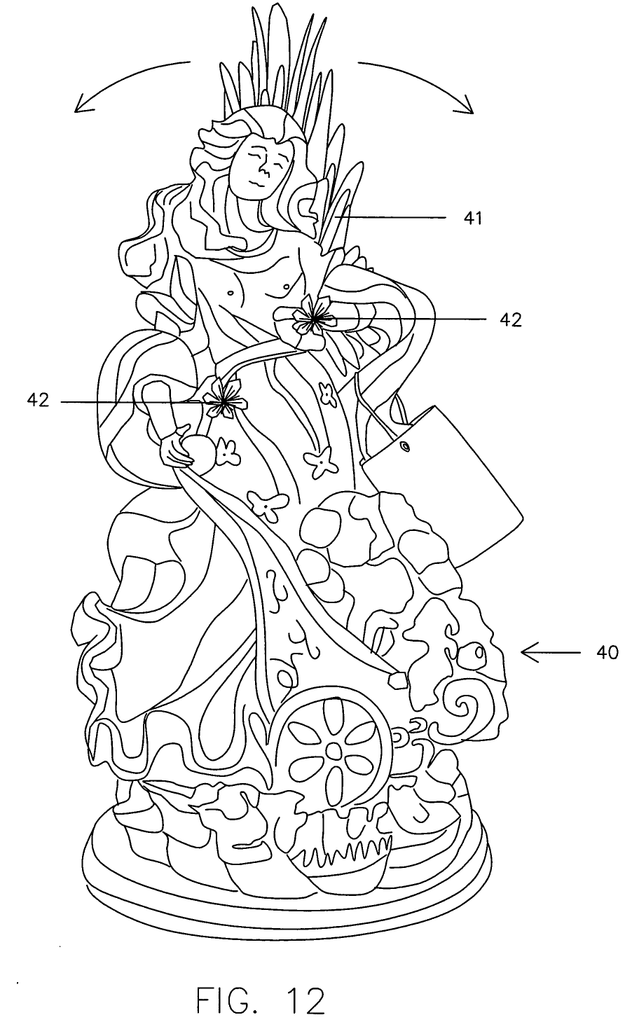

Referring to FIGS. 4-8, additionally, a pair of receiving tubes 22 extends from the base 16 each with a pair of positioning ribs (not shown) extending from inner side wall thereof. A pair of fixing tubes 36 is received in the receiving tubes 22. A pair of slots 361 is defined in each of the fixing tubes 36 for engaging with the positioning ribs of the receiving tubes 22 thereby readily positioning the fixing tubes 36 to the receiving tubes 22. Some additional parts for an ornament may be fixed to the fixing tubes 36. For example, referring to FIGS. 11-12, the angel ornament further includes two flowers 42 attached to the body 40. The flowers 42 are fixed to one of the fixing tubes 36 and then the fixing tube 36 with the flowers 42 is readily fixed to the receiving tube 22.

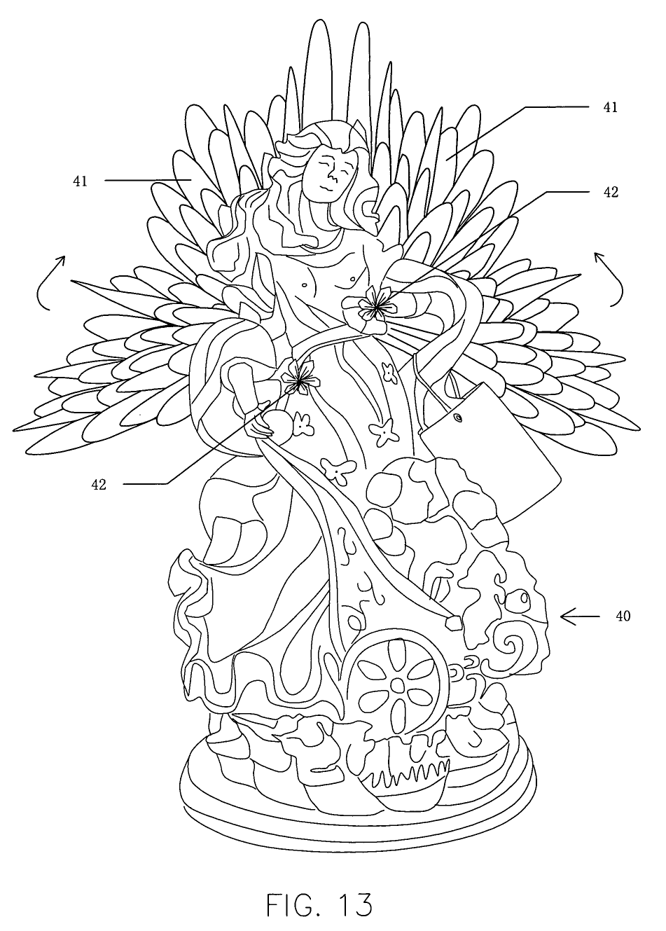

FIGS. 12-13 show that the wings 41 swing between a close position and an open position through the rotating mechanism of the present invention.

It is understood that the invention may be embodied in other forms without departing from the spirit thereof. Thus, the present example and embodiment are to be considered in all respects as illustrative and not restrictive, and the invention is not to be limited to the details given herein.

1. A rotating mechanism for an ornament comprising:
a base comprising a first transmission seat, a second transmission seat, and a pair of third transmission seats, a pair of pivot holes being defined in the second transmission seat;
a first transmission member rotatably mounted on the first transmission seat, a groove being defined in the side wall of the first transmission member;
a second transmission member mounted on the second transmission seat, the second transmission member comprising a head movably received in the groove of the first transmission member, a pair of pivots at opposite side surfaces thereof, and a pair of shoulders, the pivots being pivotably received in the pivot holes of the second transmission seat; and
a pair of third transmission members rotatably mounted on the third transmission seats respectively, each shoulder of the second transmission member movably engaging with each third transmission member;
wherein when the groove of the first transmission member actuates the head of the second transmission member thereby rotating the second transmission member about the pivots thereof, the shoulders of the second transmission member actuate the third transmission members thereby rotating the third transmission members.

2. The rotating mechanism for an ornament as claimed in claim 1, further comprising a cover attached to the base thereby fixing the first and third transmission members to the base, and a pair of sleeves received in the third transmission members respectively.

3. The rotating mechanism for an ornament as claimed in claim 1, wherein a motor is received in the base with a shaft extending therefrom and connecting with the first transmission member.

4. The rotating mechanism for an ornament as claimed in claim 1, wherein a supporter and a guide rail are formed at the base thereby cooperatively defining the second transmission seat.

5. The rotating mechanism for an ornament as claimed in claim 4, wherein the supporter comprises a pair of boards, the pivot holes are defined in the boards respectively.

6. The rotating mechanism for an ornament as claimed in claim 5, wherein a pair of L-shaped recesses is defined in the pair of boards thereby cooperatively defining a guide way, and a U-shaped recess is defined in the guide rail.

7. The rotating mechanism for an ornament as claimed in claim 6, wherein the second transmission member further comprises a guide body, the shoulders extend from opposite side surfaces of the guide body, and the guide body is movable along the guide rail and the guide way of the supporter.

8. The rotating mechanism for an ornament as claimed in claim 1, wherein each shoulder of the second transmission member is circular.

9. The rotating mechanism for an ornament as claimed in claim 1, wherein the groove comprises two symmetrical spired sections connected with each other.

10. The rotating mechanism for an ornament as claimed in claim 1, wherein each third transmission member comprises a pair of guide ribs at the peripheral side wall thereof, and each shoulder of the second transmission member is movably received between the guide ribs and movably engages with the guide ribs.

11. The rotating mechanism for an ornament as claimed in claim 10, wherein the pairs of guide ribs of the third transmission members are symmetrical whereby the transmission members rotate respectively at opposite directions.

12. The rotating mechanism for an ornament as claimed in claim 2, wherein a cutout is defined in an end wall of each third transmission member, and each sleeve comprises a protrusion for engaging with the cutout of the third transmission member thereby readily positioning the sleeve to the third transmission member.

13. The rotating mechanism for an ornament as claimed in claim 2, wherein a first through hole and a pair of second through holes are defined in the cover corresponding to the first transmission seat and the third transmission seats respectively.

14. The rotating mechanism for an ornament as claimed in claim 1, wherein a pair of receiving tubes extends from the base, a pair of fixing tubes is received in the receiving tubes respectively.

15. The rotating mechanism for an ornament as claimed in claim 14, wherein a pair of positioning ribs extends from the inner side wall of each receiving tube, and a pair of slots is defined in each of the fixing tubes for engaging with the positioning ribs of the receiving tubes thereby readily positioning the fixing tubes to the receiving tubes.

16. The rotating mechanism for an ornament as claimed in claim 3, wherein a transparent multicolored plate is attached to the rotating shaft thereby rotating with the rotating shaft.

17. The rotating mechanism for an ornament as claimed in claim 16, wherein a housing is attached to the base, a pair of lamps is mounted on the housing and under the transparent multicolored plate, and the motor is mounted on the housing.

18. A rotating mechanism for an ornament comprising:
a base comprising a first transmission seat, a second transmission seat, and a pair of third transmission seats, a supporter and a guide rail being formed at the base thereby cooperatively defining the second transmission seat, a pair of pivot holes being defined in the supporter;
a first transmission member rotatably mounted on the first transmission seat, a groove being defined in the side wall of the first transmission member, the groove comprising two symmetrical spired sections connected with each other;
a second transmission member mounted on the second transmission seat, the second transmission member comprising a head movably received in the groove of the first transmission member, a pair of pivots at opposite side surfaces thereof, and a pair of shoulders, the pivots being pivotably received in the pivot holes of the second transmission seat;
a pair of third transmission members rotatably mounted on the third transmission seats respectively, each third transmission member comprising a pair of guide ribs at the peripheral side wall thereof, each shoulder of the second transmission member being movably received between the guide ribs and movably engaging with the guide ribs; and
a cover attached to the base thereby fixing the first and third transmission members to the base;
wherein when the groove of the first transmission member actuates the head of the second transmission member thereby rotating the second transmission member about the pivots thereof, the shoulders of the second transmission member actuate the third transmission members thereby rotating the third transmission members.

19. The rotating mechanism for an ornament as claimed in claim 18, further comprising a pair of sleeves received in the third transmission members respectively.

20. The rotating mechanism for an ornament as claimed in claim 19, wherein a cutout is defined in an end wall of each third transmission member, each sleeve comprises a protrusion for engaging with the cutout of the third transmission member thereby readily positioning the sleeve to the third transmission member.
